(19) United States
(12) Patent Application Publication
(10) Pub. No.: US 2009/0180033 A1
(43) Pub. Date: Jul. 16, 2009

(54) Frame rate up conversion method and apparatus

(76) Inventor: Fang-Chen Chang, Tainan (TW)

Correspondence Address: STOUT, UXA, BUYAN & MULLINS LLP, 4 VENTURE, SUITE 300, IRVINE, CA, 92618, US

(21) Appl. No.: 11/972,858

(22) Filed: Jan. 11, 2008

(51) Int. Cl. H04N 9/64

(52) U.S. Cl. 348/720; 348/E09.037

(57) ABSTRACT

A frame rate up conversion method is disclosed. The method includes the steps of receiving a first reference frame and a second reference frame, and determining a first part in a new video frame according to the first reference frame, the second reference frame, and a second part in the new video frame. The second part includes an already-generated pixel area lying in the new video frame. An apparatus for performing the method is also disclosed.

### BACKGROUND OF THE INVENTION

1. Field of the Invention

The present invention generally relates to digital image processing technology, and more particularly to a frame rate up conversion method and apparatus

2. Description of the Prior Art

Applications of video and visual communication generally deal with large quantities of video data. To create a video presentation, a rendering device displays a plurality of digital images (“frames”) in succession, thereby simulating movement. Frame rate is the measurement of the frequency at which a rendering device produces unique consecutive frames. The term applies equally well to computer graphics, video cameras, film cameras, and motion capture systems. Frame rate is most often expressed in frames per second (fps), or simply hertz (Hz). Capability to display video in high frame rate mode is increasingly desired in modern image display application.

To increase the rate at which the frames are displayed to a user, it must generate intermediate frames between two selected reference frames of the video presentation. Frame rate up conversion methods generally employ motion compensated interpolation technique which uses motion measurement information between adjacent frames for intermediate frame interpolation.

A robust frame rate up conversion method is always required in the application regarding high frame rate video display.

### SUMMARY OF THE INVENTION

According to a preferred embodiment, the present invention provides a frame rate up conversion method including the steps of: receiving a first reference frame and a second reference frame; and determining a first part in a new video frame according to the first reference frame, the second reference frame, and a second part in the new video frame, in which the first part is a current pixel block lying in the new video frame, the second part includes an already-generated pixel area lying in the new video frame, and the current pixel block is determined according to a first group of pixel blocks lying in the first reference frame, a second group of pixel blocks lying in the second reference frame, and the already-generated pixel area.

The determining step includes computing a plurality of similarity measuring indicators for a plurality of pixel block pairs, each of the plurality of pixel block pairs containing exactly two blocks containing one pixel block selecting from the first group of pixel blocks and another pixel block selected from the second group of pixel blocks; determining an optimum pixel pair among the plurality of pixel block pairs according to the plurality of similarity measuring indicators; and generating a super current pixel block in the new video frame by averaging the two pixel blocks of the optimum pixel pair, in which the current pixel block is determined to be a sub-block lying in the super current block.

According to a preferred embodiment, the present invention also provides a frame rate up conversion apparatus including a pixel block pair generating unit, an SMI (similarity measuring indicator) computing unit 320, an optimum pixel block pair selecting unit 330, a pixel block interpolating unit 340 and an already generated blocks buffer 350.

### BRIEF DESCRIPTION OF THE DRAWINGS

FIG. 1A through FIG. 1E illustrate the related concept about a pixel block generation process in accordance with an embodiment of the present invention.

FIG. 2 summarizes the essential steps of a frame rate up conversion method in accordance with an embodiment of the present invention.

FIG. 3 shows a block diagram of a frame rate up conversion apparatus in accordance with an embodiment of the present invention.

### DETAILED DESCRIPTION OF THE INVENTION

In the following description of the exemplary embodiment, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

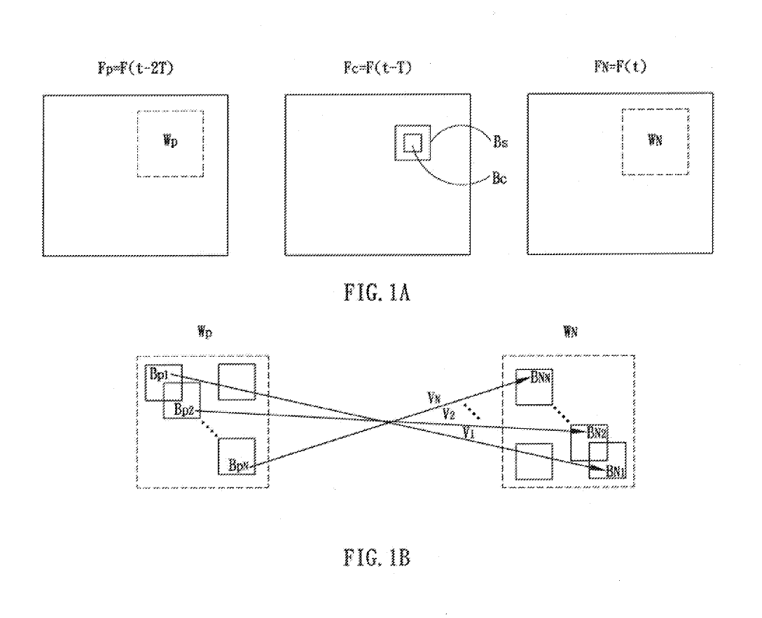

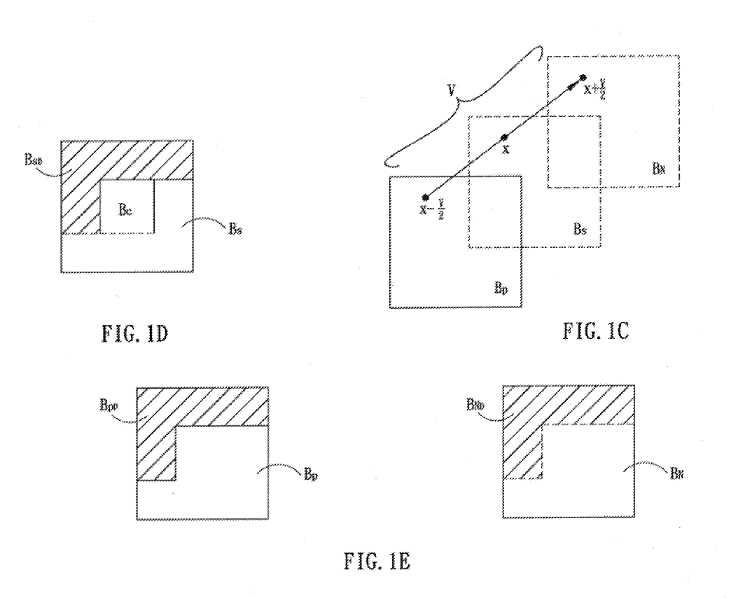

FIG. 1A through FIG. 1E illustrate the related concept about a pixel block generation process in accordance with an embodiment of the present invention. In FIG. 1A, a video frame F_{C} is newly generated based on a first reference frame F_{P} and a second reference frame F_{N}. In this embodiment, the first reference frame F_{P} and the second reference frame F_{N} are respectively video frames prior to and subsequent to the newly generated video frame F_{C} in temporal sequence. Furthermore, the temporal distance between the first reference frame F_{P} and the newly generated video frame F_{C} is equal to the temporal distance between the second reference frame F_{N} and the newly generated video frame F_{C}. In the following description, the temporal distance is designated as T. As shown in FIG. 1A, the first reference frame F_{P}, the second reference frame F_{N} and the newly generated video frame F_{C} may then be generally designated as functions of time F(t-2T), F(t-T) and F(t) respectively.

In the newly generated video frame F_{C}, the pixel block B_{C} is the current or instant block to be generated. In this embodiment, the pixel block B_{C} is an 8×8 pixel area, i.e., an area containing 8×8=64 pixels. The pixel block B_{C} is located within a super pixel block B_{S} which is a 16×16 pixel area in this embodiment.

The pixel block generation process firstly tries to determine whether the super pixel block B_{S} is a part of an object lying in both the first reference frame F_{P} and the second reference frame F_{N}. For this purpose, a first group of pixel blocks G_{P} within a first search range W_{P} in the first reference frame F_{P} and a second group of pixel blocks G_{N} within a second search range W_{N} in the second reference frame F_{N} are determined in an appropriate manner. Pixel blocks contained in the first group G_{P} may be overlapped with each other. Likewise, pixel blocks contained in the second group G_{N} may also be overlapped with each other. Each pixel block contained in the first group G_{P} is a candidate pixel block to be determined whether it is the same block as another pixel block contained in the second group G_{N}. FIG. 1B illustrates this situation by showing some pixel blocks lying within the first search range W_{P} and the second search range W_{N}, in which the pixel block B_{P1} is overlapped with the pixel block B_{P2} in the first search range W_{P}. Similarly, the pixel block B_{N1} is overlapped with the pixel block B_{N2} in the second search range W_{N}. Note that only a part of candidate pixel blocks are shown in FIG. 1B for exemplary purpose.

A plurality of pixel block pairs are then determined in a feasible manner such that each of the pixel pair contains exactly one pixel block selecting from the first group G_{P} and another pixel block selecting from the second group G_{N}. FIG. 1B explicitly illustrates three such pixel block pairs which are shown connecting with each other through arrow signs V1, V2 and Vn. The arrow signs V1-Vn designate the concept similar to the one generally referred to as the motion vector in image coding technology, and represent displacement measurement for pixel blocks between different frames. Such arrow signs will be hereinafter alternatively referred to as motion vectors.

Each pixel block pair is deliberately chosen such that the motion vector associated therewith can be used to locate the aforementioned super pixel block B_{S}. Referring to FIG. 1C, for example, let V be the motion vector associated with the pixel block pair B_{P} and B_{N}, i.e., each pixel x (hereinafter, location or coordinate of a pixel x is alternatively referred to as the pixel x) in B_{P} moves to a pixel x+V in B_{N}. Each pixel x in B_{P} is then supposed to move to a pixel x+V/2 in B_{S}, i.e., uniform motion during the time duration T (the aforementioned time distance between frames) is assumed. Although shown in the same plane, it should be noted that the pixel blocks B_{P}, B_{S} and B_{N} are respectively located in the first reference frame F_{P}, the newly generated frame F_{C} and the second reference frame F_{N}.

Any suitable methods, such as full search or 3-steps search, may be employed to determine the first group G_{P}, the second group G_{N}, as well as the plurality of pixel block pairs. For example, the full search technique completely searching the entire W_{P} and W_{N} is feasible for this purpose.

A similarity measuring indicator SMI is then computed for each of the plurality of pixel block pairs. The similarity measuring indicator SMI for the pixel block pair (B_{P},B_{N}) may be defined by the following expression:

SMI(B_{P},B_{N})=SAD(B_{P},B_{N})+SAD(B_{PD},B_{SD})*r+SAD(B_{ND},B_{SD})*r,

in which SAD(Bᵢ,Bⱼ) represents the sum of absolute difference between pixel areas Bᵢ and Bⱼ, and r is a scaling factor typically between 0 and 1.

The pixel area B_{SD} contains pixels already generated within the super pixel block B_{S} in previous operation. FIG. 1D illustrates an example of the already-generated pixel area B_{SD} in the super pixel block B_{S}. In general, pixels above and to the left of the current block B_{C} (as mentioned above, which is the instant block to be generated) are all pixels already generated in previous operation. In FIG. 1D, the area marked with oblique lines represents the already-generated pixel area B_{SD}.

Sub-areas B_{PD} and B_{ND} represent areas corresponding to the already-generated pixel area B_{SD} within the pixel blocks B_{P} and B_{N} respectively. FIG. 1E shows the sub-areas B_{PD} and B_{ND} with respect to the already-generated pixel area B_{SD} shown in FIG. 1D. Likewise, the area marked with oblique lines represents the sub-areas B_{PD} and B_{ND}.

An optimum pixel block pair is then determined among the plurality of pixel block pairs such that the optimum pixel block pair generates a minimum similarity measuring indicator among the plurality of similarity measuring indicators computed therefor. After the optimum pixel block pair is determined, the content of the super current pixel block B_{S} may then be obtained by averaging the two pixel blocks contained in the optimum pixel pair. Note that the current pixel block B_{C} is determined when the super current pixel block B_{S} is determined, because, as shown in FIG. 1A, the current pixel block BC is a sub-block lying in the super current pixel block B_{S}.

In other embodiment, the dimension of the pixel block under processing is not necessarily 16×16 or 8×8. The width and length of the pixel block under processing may even be different. The pixel block under processing, for example, may be an M×N pixel area and M is not equal to N. Furthermore, the function SAD(Bᵢ,Bⱼ) may be replaced with any other suitable function measuring pixel block difference.

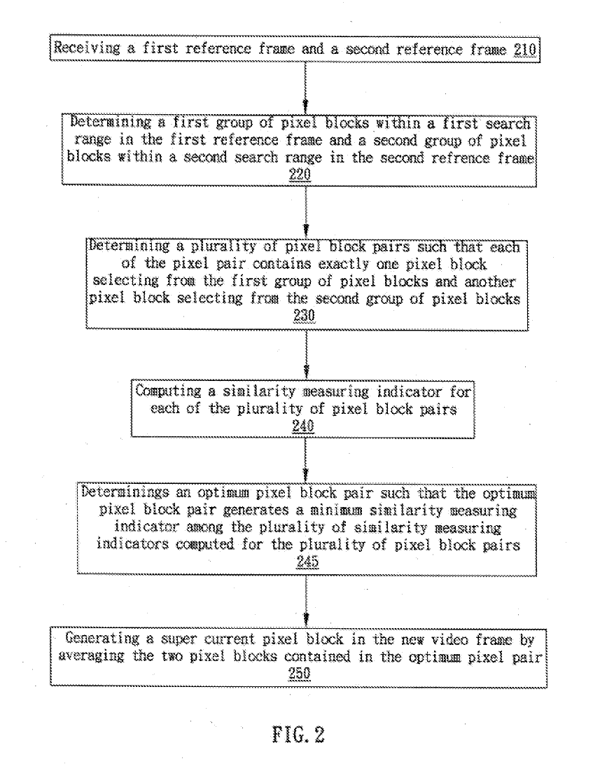

The pixel block generation process described above may be used in a frame rate up conversion method. FIG. 2 summarizes the essential steps of a frame rate up conversion method in accordance with an embodiment of the present invention. A first reference frame and a second reference frame are received in step 210. Steps 220 through 250 may then be invoked, when necessary, in the new video frame generating process for the frame rate up conversion method. Step 220 determines a first group of pixel blocks within a first search range in the first reference frame and a second group of pixel blocks within a second search range in the second reference frame. Step 230 determines a plurality of pixel block pairs such that each of the pixel pair contains exactly one pixel block selecting from the first group of pixel blocks and another pixel block selecting from the second group of pixel blocks. Step 240 computes a similarity measuring indicator for each of the plurality of pixel block pairs. Step 245 determines an optimum pixel block pair such that the optimum pixel block pair generates a minimum similarity measuring indicator among the plurality of similarity measuring indicators computed for the plurality of pixel block pairs. Step 250 generates a super current pixel block in the new video frame by averaging the two pixel blocks contained in the optimum pixel pair.

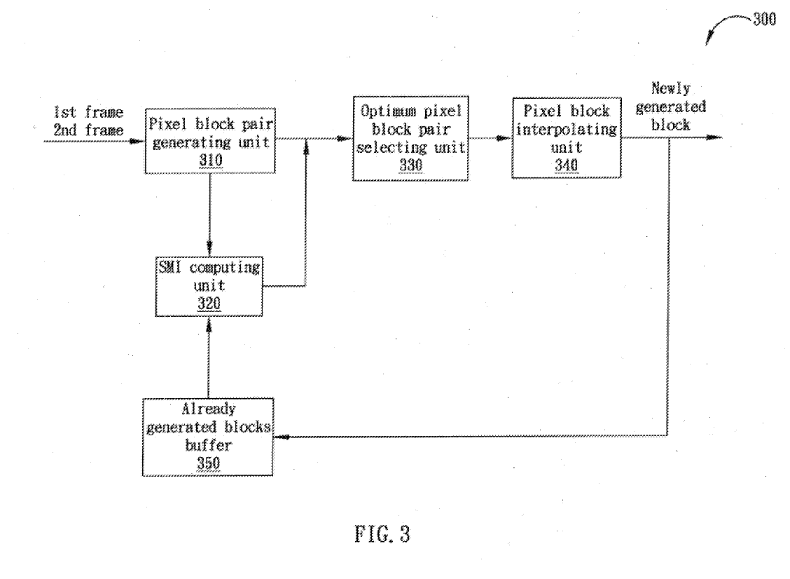

The present invention also includes an apparatus implementing the method disclosed above. FIG. 3 shows a block diagram of a frame rate up conversion apparatus 300 in accordance with an embodiment of the present invention. In general, the frame rate up conversion apparatus 300 may be an independent chip or a portion of a digital image processing chip. The frame rate up conversion 300 includes a pixel block pair generating unit 310, an SMI (similarity measuring indicator) computing unit 320, an optimum pixel block pair selecting unit 330, a pixel block interpolating unit 340 and an already generated blocks buffer 350.

Please also refer to FIG. 2 for the following description. The pixel block pair generating unit 310 may execute steps 210 through 230 to receive a first reference frame and a second reference frame, determine a first group of pixel blocks within a first search range in the first reference frame and a second group of pixel blocks within a second search range in the second reference frame, and determines a plurality of pixel block pairs such that each of the pixel pair contains exactly one pixel block selecting from the first group of pixel blocks and another pixel block selecting from the second group of pixel blocks. The SMI computing unit 320 may execute step 240 to compute a similarity measuring indicator for each of the plurality of pixel block pairs. The optimum pixel block pair selecting unit 330 may execute step 245 to determine an optimum pixel block pair such that the optimum pixel block pair generates a minimum similarity measuring indicator among the plurality of similarity measuring indicators computed for the plurality of pixel block pairs. The pixel block interpolating unit 340 may execute step 250 to generate a super current pixel block in the new video frame by averaging the two pixel blocks contained in the optimum pixel pair. The already generated blocks buffer 350 is a specific memory location keeping the current pixel block which is a sub-block lying in the super current pixel block generated in the pixel block interpolating unit 340.

In a preferred embodiment, all the units (except the buffer 350) described in FIG. 3 are implemented as logic elements in an ASIC (Application Specific Integrated Circuit). In other embodiments according to the present invention, such units may also be implemented as software or hardware modules in a DSP (Digital Signal Processing) based system or a microprocessor based system. In addition, the already generated blocks buffer 350 is typically composed of DRAM (dynamic random access memory), but may be any other feasible volatile memory.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A frame rate up conversion method, comprising the steps of:
receiving a first reference frame and a second reference frame; and
determining a first part in a new video frame according to said first reference frame, said second reference frame, and a second part in said new video frame,
wherein said first and second parts respectively comprise two pixel areas in said new video frame.

2. The method of claim 1, wherein said first part is a current pixel block lying in said new video frame, wherein said second part comprises an already-generated pixel area lying in said new video frame, and wherein said current pixel block is determined according to a first group of pixel blocks lying in said first reference frame, a second group of pixel blocks lying in said second reference frame, and said already-generated pixel area.

3. The method of claim 2, wherein said determining step comprises:
computing a plurality of similarity measuring indicators for a plurality of pixel block pairs, each of said plurality of pixel block pairs containing exactly two blocks containing one pixel block selecting from said first group of pixel blocks and another pixel block selected from said second group of pixel blocks;
determining an optimum pixel pair among said plurality of pixel block pairs according to said plurality of similarity measuring indicators; and
generating a super current pixel block in the new video frame by averaging said two pixel blocks of said optimum pixel pair,
wherein said current pixel block is determined to be a sub-block lying in said super current block.

4. The method of claim 3, wherein said optimum pixel pair generates a minimum similarity measuring indicator among said plurality of similarity measuring indicators.

5. The method of claim 3, wherein said similarity measuring indicator comprises a weighting sum of a first block difference, a second block difference and a third block difference, said first block difference being a difference measurement between a first pixel block selecting from said first group of pixel blocks and a second pixel block selected from said second group of pixel blocks, said second block difference being said difference measurement between said already-generated pixel area and its corresponding sub-area in said first block, and said third block difference being said difference measurement between said already-generated pixel area and its corresponding sub-area in said second block.

6. The method of claim 5, wherein said difference measurement is a sum of absolute difference between pixel blocks or corresponding sub-areas of pixel blocks.

7. The method of claim 5, wherein said weighting sum equals said first difference plus said second difference multiplied by a scaling factor plus said third difference multiplied by said scaling factor, said scaling factor being a number between 0 and 1.

8. The method of claim 1, wherein said first and second reference frames are respectively video frames prior to and subsequent to said new video frame in temporal sequence.

9. A frame rate up conversion apparatus, comprising:
a pixel block pair generating unit, configured to receive a first reference frame and a second reference frame, determine a first group of pixel blocks within said first reference frame and a second group of pixel blocks within said second reference frame, and determine a plurality of pixel block pairs such that each of said pixel pair contains exactly two blocks containing one pixel block selecting from said first group of pixel blocks and another pixel block selecting from said second group of pixel blocks;
an SMI computing unit, configured to compute a plurality of similarity measuring indicators for said plurality of pixel block pairs;
an optimum pixel block pair selecting unit, configured to determine an optimum pixel pair among said plurality of pixel block pairs according to said plurality of similarity measuring indicators;
a pixel block interpolating unit, configured to generate a super current pixel block in the new video frame by averaging said two pixel blocks of said optimum pixel pair; and
an already generated blocks buffer for storing a sub-block lying in said super current pixel block generated in said pixel block interpolating unit,
wherein said similarity measuring indicator is computed based on said first reference frame, said second reference frame, and data already stored in said already generated blocks buffer.

10. The frame rate up conversion apparatus of claim 9, wherein said optimum pixel pair generates a minimum similarity measuring indicator among said plurality of similarity measuring indicators.

11. The frame rate up conversion apparatus of claim 9, wherein said similarity measuring indicator comprises a weighting sum of a first block difference, a second block difference and a third block difference, said first block difference being a difference measurement between a first pixel block selecting from said first group of pixel blocks and a second pixel block selected from said second group of pixel blocks, said second block difference being said difference measurement between an already-generated pixel area and its corresponding sub-area in said first block, and said third block difference being said difference measurement between said already-generated pixel area and its corresponding sub-area in said second block, said already-generated pixel area being data already stored in said already generated blocks buffer.

12. The frame rate up conversion apparatus of claim 11, wherein said difference measurement is a sum of absolute difference between pixel blocks or corresponding sub-areas of pixel blocks.

13. The frame rate up conversion apparatus of claim 11, wherein said weighting sum equals said first difference plus said second difference multiplied by a scaling factor plus said third difference multiplied by said scaling factor, said scaling factor being a number between 0 and 1.
